(19) United States
(12) Patent Application Publication
(10) Pub. No.: US 2024/0112574 A1
(43) Pub. Date: Apr. 4, 2024

(54) DEVICE, METHOD AND SYSTEM FOR DETECTING PARKED VEHICLES

(71) Applicant: Municipal Parking Services, Inc., Minnetonka, MN (US)

(72) Inventors: Mark J. MORAN, New Richmond, WI (US); James MARTIN, Minneapolis, MN (US); James CONLAN, Minneapolis, MN (US); Richard W. KELLEY, II, Eagan, MN (US); Steven B. LANE, Maple Grove, MN (US); Alexander J. PALUMBO, St. Paul, MN (US); Marcus N. SCHMIDT, Minnetonka, MN (US); Joseph M. CALDWELL, Chanhassen, MN (US)

(21) Appl. No.: 18/376,275

(22) Filed: Oct. 3, 2023

Related U.S. Application Data
(60) Provisional application No. 63/412,852, filed on Oct. 3, 2022.

(51) Int. Cl. G08G 1/017; G06V 20/54; H04N 7/18

(52) U.S. Cl. CPC G08G 1/0175; G06V 20/54; H04N 7/183; G06V 2201/08

(57) ABSTRACT

A parking enforcement device can be secured to a surface adjacent to the area designated as NO PARKING. The enforcement device can include an elongated hollow body, a window provided to the tubular body, a battery, an internal frame assembly disposed inside of the elongated hollow body, and a camera disposed inside of the elongated hollow body. The internal frame assembly defines a cavity in which the battery is located. A camera support pole extends vertically upwards from the internal frame assembly. The camera is secured to the camera support pole and located vertically along the camera support pole such that the camera views outward through the window. A solar panel can be provided atop the parking enforcement device to recharge the battery.

### PRIORITY

This application claims priority to and the benefit of U.S. Provisional Patent Application No. 63/412,852, filed Oct. 3, 2022, which is incorporated fully herein by reference.

### FIELD

The present invention relates generally to parking enforcement systems and, more particularly, to methods, systems and devices for automatically detecting the presence of a vehicle in a location where parking is prohibited.

### BACKGROUND

There are many locations where it is undesirable for vehicles to park. For example a vehicle is a safety hazard if parked in a fire lane, in a bike lane or too near a fire hydrant. Unfortunately, clearly marking such “no parking” areas does not deter some people from parking there anyway. Thus, it is necessary to issue parking violation notices (e.g., parking tickets) to persons that park where prohibited. Such violations typically require a fine to be paid. However, escalating penalties can be levied.

In order to issue a parking violation notice, citation or ticket to an illegally parked vehicle, a person authorized to issue parking citations (e.g. police officer or parking enforcement officer) must issue the notice to the vehicle when it is in the illegal parking location. A given officer cannot monitor everywhere at once and illegal parking is often short term in nature. Thus, many violations are not cited. Adding more enforcement officers cannot realistically capture all illegal parking acts. And adding more officers adds significant costs to the enforcement process.

Thus, there is a need to make the citation process automated for prohibited parking areas so that fewer violations go uncited and without increasing enforcement costs by adding more enforcement officers.

### SUMMARY

Disclosed are devices, systems and methods for monitoring and managing enforcement of prohibited or “no parking” areas. In one aspect, a “no parking” enforcement device can include an embedded processor and microcontroller used to operate timers, decorative and targeted lights, cameras, and vehicle detection sensing (magnetometer, radar, etc. . . . ) means. The enforcement device is connected to the internet through either hard-wiring, Wi-Fi, a cellular modem or other wireless means. Power is supplied via hard-wiring, battery, and/or solar panels.

The enforcement device can be configured in the form of a bollard and monitor a single or multiple areas that have been designated by a governmental authority as “No Parking” areas. The enforcement device can be mounted adjacent the area(s) where a “No Parking” condition is desired to be enforced. A variety of vehicle detection means can be employed to detect a vehicle in the “No Parking” location. A violation notice and pertinent vehicle data and images are relayed to a remote computer system or to the municipality for processing and issuance of a parking citation to the vehicle's owner.

The parking enforcement device can be secured to a surface adjacent to the area designated as NO PARKING or to any other structure or can be incorporated into other traffic control devices or items of infrastructure (e.g. light poles).

In an example embodiment, the enforcement device can include an elongated hollow body, a window provided to the tubular body, a battery, an internal frame assembly disposed inside of the elongated hollow body, and a camera disposed inside of the elongated hollow body. The internal frame assembly defines a cavity in which the battery is located. A camera support pole extends vertically upwards from the internal frame assembly. The camera is secured to the camera support pole and located vertically along the camera support pole such that the camera views outward through the window. A solar panel can be provided atop the parking enforcement device to recharge the battery.

The window can be a portion of the elongated hollow body or it can be a separate assembly disposed on the elongated hollow body. A cap can be disposed vertically atop the elongated hollow body. A top surface of the cap can include a planar surface that is angled to intersect a horizontal plane. A solar panel can be disposed on the top surface of the cap.

A plurality of solar cells can be disposed on a surface on top of the elongated hollow body. The surface on top of the elongated hollow body can be a planar surface that is angled to intersect a horizontal plane.

A pair of battery enclosure panels can be secured to the internal frame assembly and located such that the pair of battery enclosure panels enclose the cavity in which the battery is located.

The elongated hollow body can be disposed atop the base plate.

The elongated hollow body can have a constant outer diameter from a top to a bottom thereof.

An electronics board can be secured to the internal frame assembly. The electronics board can include a control board comprising a microprocessor and memory. The camera can be electronically coupled to the control board. The electronics board includes wireless communications means. The electronics board can include a solar charge controller that is electrically coupled to the plurality of solar calls and to the battery. The electronics board can include an impact sensor.

The processor can be configured to monitor an area designated as NO PARKING for the presence of a vehicle in the area designated as NO PARKING. The processor can be configured to utilize the camera aimed at the area designated as NO PARKING to perform a machine vision analysis of the area designated as NO PARKING for the presence of vehicles in the area designated as NO PARKING. The processor can be configured to utilize the camera to capture an image of a license plate of the vehicle in the area designated as NO PARKING and transmit the image of the license plate to a back office computing system. The back office computing system can analyze the image data to determine the make, model and/or color of the vehicle in the monitored area.

The processor can be configured to determine that a parking violation has occurred upon determining that the vehicle is present in the area designated as NO PARKING or upon expiration of a grace period after entering said area. The processor can be configured to initiate a request for towing services upon an expiration of a predetermined period of time following a determination that the vehicle is present in the area designated as NO PARKING without the vehicle having left the area designated as NO PARKING. Image data of the entry of a vehicle into the NO PARKING area that was captured by the camera can be relayed to a remote computing system such as a back office or central control computing system.

The above summary is not intended to limit the scope of the invention, or describe each embodiment, aspect, implementation, feature or advantage of the invention. The detailed technology and preferred embodiments for the subject invention are described in the following paragraphs accompanying the appended drawings for people skilled in this field to well appreciate the features of the claimed invention. It is understood that the features mentioned hereinbefore and those to be commented on hereinafter may be used not only in the specified combinations, but also in other combinations or in isolation, without departing from the scope of the present invention.

### BRIEF DESCRIPTION OF THE DRAWINGS

FIG. 1 is a perspective view of a parking enforcement device in accordance with certain example embodiments of the invention.

FIG. 2 is a partial exploded perspective view of the parking enforcement device of FIG. 1 in accordance with certain example embodiments of the invention.

FIG. 3 is a top view of the parking enforcement device of FIG. 1 in accordance with certain example embodiments of the invention.

FIG. 4 is a front of the parking enforcement device of FIG. 1 in accordance with certain example embodiments of the invention.

FIG. 5 is a bottom view of the parking enforcement device of FIG. 1 in accordance with certain example embodiments of the invention.

FIG. 6 is a side view of the parking enforcement device of FIG. 1 in accordance with certain example embodiments of the invention.

FIG. 7 is a perspective view of a portion of a parking enforcement device showing internal structure in accordance with certain example embodiments of the invention.

FIG. 8 is an exploded perspective view of the parking enforcement device of FIG. 7 in accordance with certain example embodiments of the invention.

FIG. 9 is a side view of the parking enforcement device of FIG. 7 in accordance with certain example embodiments of the invention.

FIG. 10 is a top view of the parking enforcement device of FIG. 7 in accordance with certain example embodiments of the invention.

FIG. 11 is an illustration of a vehicle illegally parked in a NO PARKING zone in a location being monitored by a parking enforcement device in accordance with certain example embodiments of the invention.

FIG. 12 is an illustration of a vehicle illegally parked in a NO PARKING zone in a location being monitored by multiple parking enforcement devices in accordance with certain example embodiments of the invention.

While the invention is amenable to various modifications and alternative forms, specifics thereof have been shown by way of example in the drawings and will be described in detail. It should be understood, however, that the intention is not to limit the invention to the particular example embodiments described. On the contrary, the invention is to cover all modifications, equivalents, and alternatives falling within the scope of the invention as defined by the appended claims.

### DETAILED DESCRIPTION

In the following descriptions, the present invention will be explained with reference to various exemplary embodiments. Nevertheless, these embodiments are not intended to limit the present invention to any specific example, environment, application, or particular implementation described herein. Therefore, descriptions of these example embodiments are only provided for purpose of illustration rather than to limit the present invention.

Any dimensional information provided herein and indicated in the figures is for certain preferred embodiments. It should be recognized, however, that the dimensions, proportions, scale and configurations of components are merely example embodiments and can be varied unless specifically limited in a given claim. Thus, the dimensions, proportions, scale and configurations can be varied without departing from the scope of the invention except where explicitly limited by a given claim.

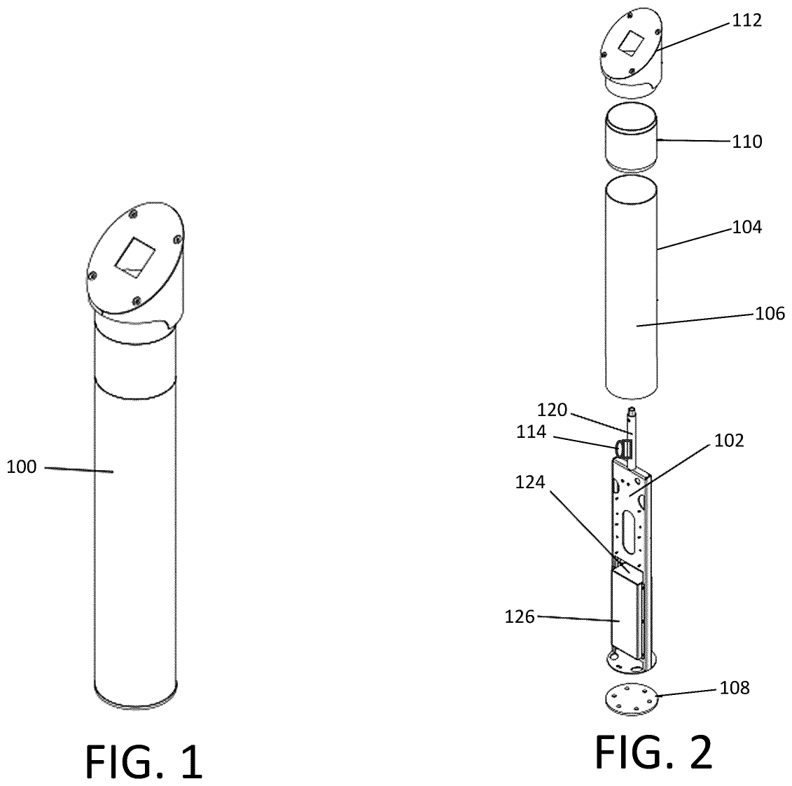

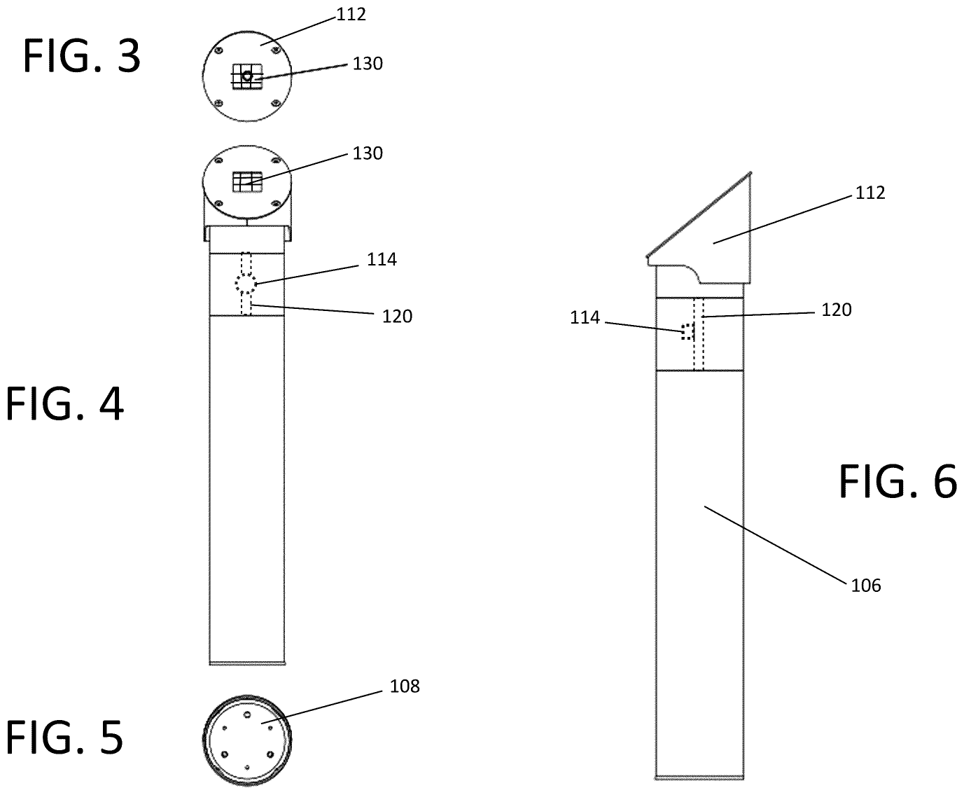

Referring to FIGS. 1-10, the depicted “no parking” enforcement device 100 is configured in the form of a bollard. The bollard can also be configured to monitor parking events in locations where parking is allowed. In the latter situation, the bollard 100 is networked with a kiosk or a nearby parking meter that includes a user interface and payment acceptor means, such as that disclosed in U.S. Pat. No. 9,773,351, which is incorporated herein by reference in its entirety. Moreover, the entirety of U.S. Pat. No. 10,885,367 is hereby incorporated herein by reference.

The enforcement bollard 100 generally comprises an internal frame assembly 102 enclosed within an outer enclosure 104. The fully assembled bollard 100 is shown in FIG. 1 and an exploded view thereof is shown in FIG. 2. The outer enclosure 104 comprises a tubular body 106 disposed atop a base plate 108, with a transparent (or semi-transparent) window 110 disposed atop the tubular body 106, and a cap 112 disposed atop the window 110.

The window 110 allows the camera or cameras 114 inside of the outer enclosure 104 to see through the enclosure 104 to the location being monitored for illegal parking while still being protected inside of the enclosure 104. The window 110 can be a hollow tubular shape as shown in the figures, or one or more discreet window panels can be provided in the tubular body 106 in alternative embodiments.

The tubular body 106 can also have other elongated tubular shapes besides circular, such as square, triangular, octagonal or polygonal or other cross-sectional shape. Rubber gaskets can be disposed between components to further enhance the weather-proof performance of the bollard 100.

The tubular body 106, base plate 108 and top cap 112 can be formed of metal. The window 110 can be formed of plastic. The internal frame assembly 102 can be formed of metal, plastic or other rigid materials, or a combination of different rigid materials.

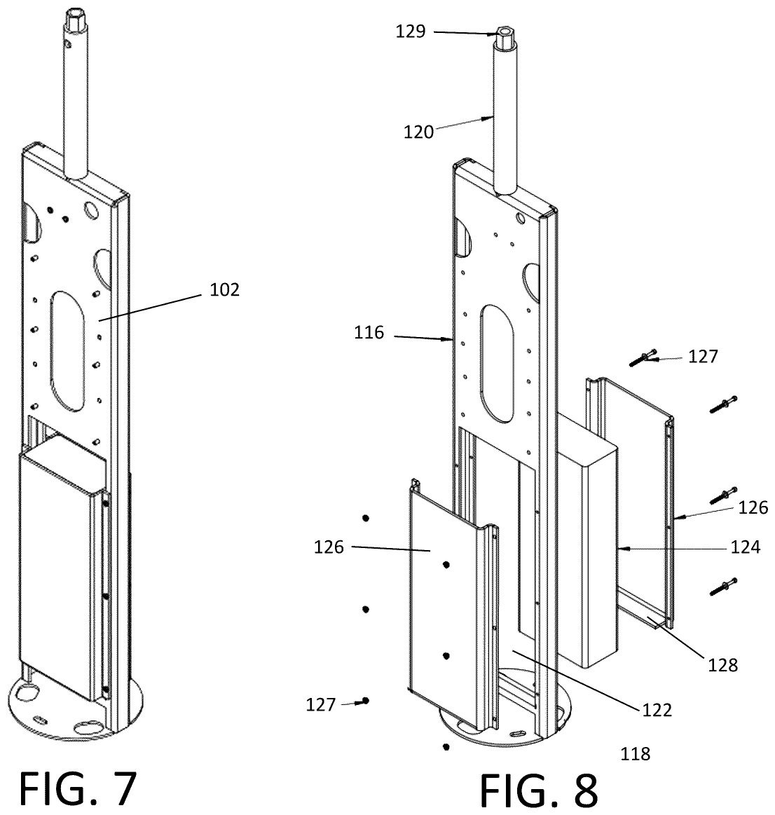

Referring particularly to FIGS. 7-10, the internal frame assembly 102 generally comprises a vertically-extending rectangular main support member 116 disposed vertically atop a base 118 with a camera support shaft 120 extending vertically upward atop the main support member 116. The main support member 116 defines a cavity 122 adjacent to the base so that a battery 124 can be placed inside of the outer enclosure 104 to provide power for the cameras 114 and other electronics disposed inside of the outer enclosure 104. A pair of battery enclosure panels 126 are fastened to the opposing major sides of the main support member 116 such that the cavity 122 is enclosed by the main support member 116 and the battery enclosure panels 126 to enclose and protect the battery 122.

Each battery enclosure panel 126 is generally U-shaped when viewed from vertically above. A bottom lip 128 is provided to enclose the bottom portion of the battery cavity 122. A plurality of fasteners 127 (e.g. screws and nuts) can be used to secure the opposing battery enclosure panels 126 together.

The camera support shaft 120 can be used to securely mount the camera(s) 114 and other electronics. The center of the shaft 120 is hollow so that an electrical conduit can be passed from the cap 112 downwards to the electronics located vertically lower inside of the enclosure 104. The camera support shaft 120 extends vertically and longitudinally through the window section 110. The top portion of the support shaft 120 can be threaded (or provided with a threaded insert 129) so that the top cap can be fastened to the support shaft 120.

Referring again to FIGS. 1-10 generally, a panel of solar cells 130 is disposed in the cap or atop the cap 112. The top surface of the cap 112 defines a plane that is angled so that the solar panel 120 is closer to perpendicular to the inbound solar radiation versus a solar panel that is horizontally aligned. The angle of the cap's top surface also encourages moisture and debris to run off of the solar panel.

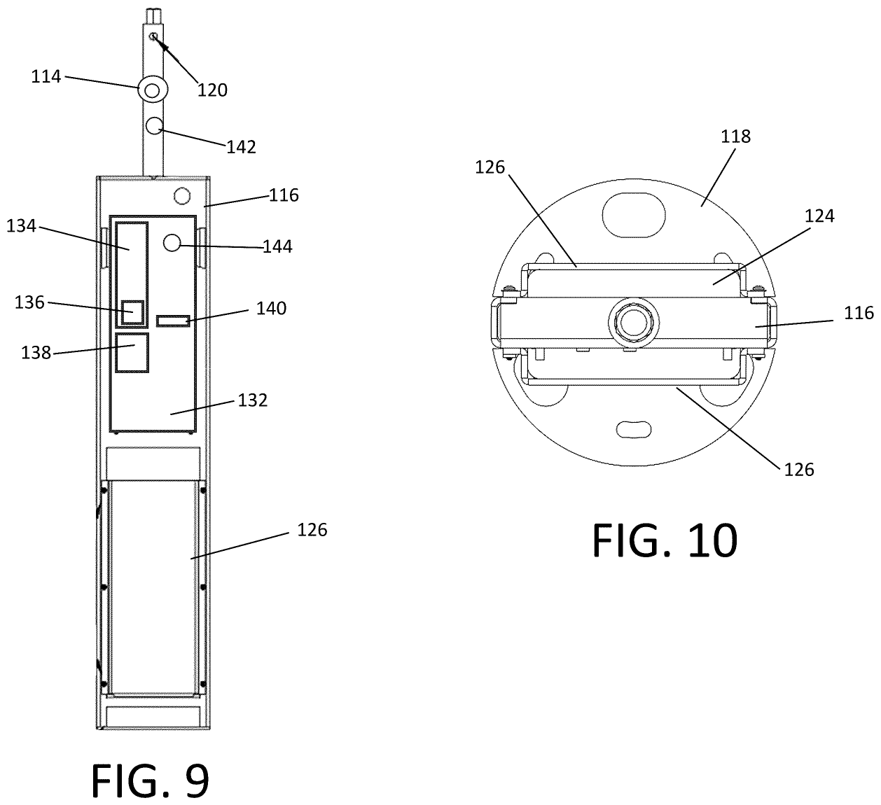

As shown in FIG. 9, an electronics board 132 can be provided inside of the outer enclosure 104 and secured to a broad side of the internal frame assembly 102. The electronics board 132 can include all the control electronics for operation of the enforcement bollard 100. Alternatively, the electronics board 132 can be disposed inside of the battery cavity 122 or integrated into the battery assembly 124 itself. More than one electronics board 132 can be provided as well.

The electronics board 132 can comprise a flat mounting plate that is secured to the internal frame assembly 102 with clamps and/or fasteners to provide a support surface for mounting a PCB (printed circuit board) control board 134 and other electrical circuit components. Those circuit components include the physical processor, controller and memory components that control operation of the bollard 100. Cables can be provided to connect each of the cameras 114 to respective terminals on control board 134.

The control board 134 can also include the wireless communication componentry, such as Bluetooth, Wi-Fi, cellular modem, wireless interface, or other wireless communications means. A solar charge controller 136 can be included in the electronic components on the board 134 to control charging of the battery 124.

A terminal connection block 138 can also be secured to electronics board 132 and located adjacent to the control board 134. The connection block 138 provides a plurality of connection points for conduits connecting various electrical components, such as the battery 124, the solar cells 130, solar charge controller 136, and any lights, with the control electronics disposed on the board 132.

A computer readable program code (e.g., software code) can be stored in the physical memory (e.g., random access memory, flash memory or hard-drive) of the device. The computer readable program code is configured such that when executed by the controller or processor, the code causes the device to perform the steps of the invention described herein.

An impact sensor 140 can be located within the bollard and coupled to the processor. The impact sensor 140 can be provided to the electronics board 132 or integrated into the control board 134. The impact sensor 140 senses impacts above a threshold force value such as might be encountered by vandalism or a vehicle strike. If such an impact is sensed, the processor transmits a communication of the impact event to a central control computer for further investigation and possible repairs.

The battery 124 can be a single cell or multiple cells in a common enclosure, or multiple separate battery enclosures can be provided. The battery 124 can be of sufficient capacity to provide all power required for operation of the bollard's electronic components. Thus, the bollard 100 in certain embodiments can be completely wireless.

The battery 124 can be of any type that can be fit inside of the bollard and provide storage capacity desired by the user. The battery 124 can be selected and configured so that no supplemental heating or cooling is required. However, in alternative embodiments, a heating element can be provided to warm the battery in case of exposure to extremely cold environments that may pose a danger to the battery. Likewise, a ventilation fan can be provided in alternative embodiments to the bollard to provide ventilation to cool the battery to prevent overheating. A temperature sensor can be provided to allow the microprocessor to determine when to operate the heating and ventilation devices when so equipped.

A status light 142 can be provided to the bollard 100. In one example, the light 142 is attached to the camera support shaft 120 and aimed so that it can be seen from outside of the bollard 100 through the window 110. The light 142 can be used as a violation notice light. For example, if the bollard 100 were being used as a parking space monitor device, then the light 142 could be green to indicate that the space is available for parking or that the space is paid for and will not imminently expire. A yellow light may indicate that time is about to expire or that a grace period is currently counting down. A red light can indicate that a violation has occurred. If the bollard 100 is configured to monitor a no parking location, the light 142 may be omitted or not used or may be lighted red at all times. The light 142 can be flashed to further call attention to the no parking status if a vehicle attempts to enter the no parking area being monitored.

A speaker 144 can be provided to the bollard 100 so that the bollard can issue audible warning tones or spoken words to serve as notices or warnings to persons that attempt to park in a no parking location. The speaker 144 can be disposed on the electronics board 132 or other convenient location. Openings can be provided in the outer enclosure 104 if necessary to allow for emission of the audible tone or words.

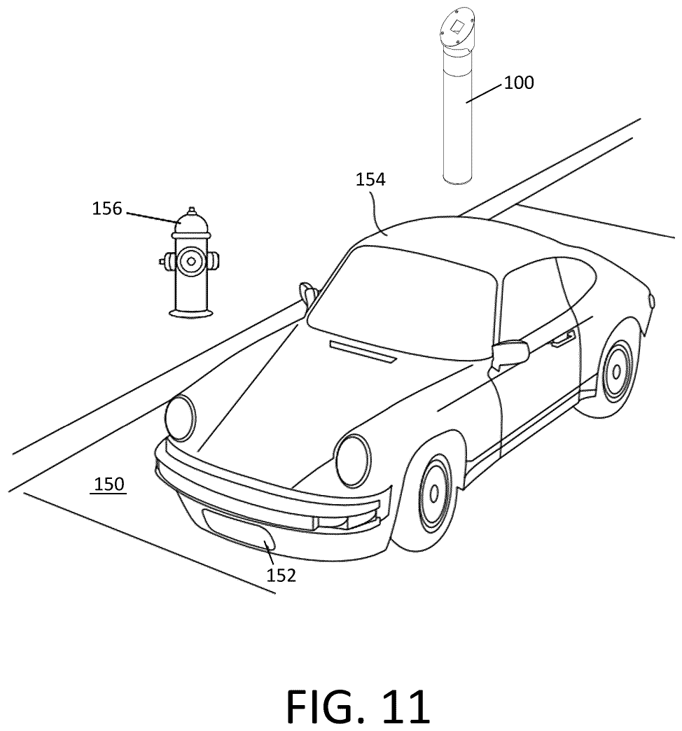

Use of the parking monitoring and enforcement bollard 100 will now be described with reference to FIG. 11. The bollard 100 is disposed adjacent to a designated NO PARKING area 150 by securing it to the ground, pavement or sidewalk. The camera 114 in the bollard 100 is aimed to view through the window so that the license plate 152 of the vehicle 154 is captured by the camera 114.

In the example shown in FIG. 11, parking in area 150 is prohibited because the space is adjacent to a fire hydrant 156. However, the area 150 could be designated as NO PARKING for any lawful reason, including being within a crosswalk, on a snow emergency route, in a loading zone, in a lane of moving traffic, etc. The area being monitored 150 is preferably marked by appropriate conventional designations to warn potential parkers of the NO PARKING status.

In FIG. 11, the vehicle 154 is shown as having entered the monitored area 150. The vehicle's presence is sensed (detected) by the bollard 100 upon entry into the monitored space 150. Vehicle detection can be performed using the camera(s) of the bollard solely by machine vision algorithms, such as background subtraction, edge detection, pattern recognition, or a combination thereof. However, other sensors, such as magnetometer, radar, and sonar sensors can be included within the enclosure 104 of the bollard 100, or can be provided externally or remotely located from the bollard 100. A further window can be provided, if necessary, for the non-image sensors inside of the bollard 100. One or more of the sensors can be located remote from the enclosure in a further alternative embodiment. Machine vision can be combined with one or more of these other detection means to operate as a double-check to confirm that the vehicle has been detected in the NO PARKING space. Vehicle detection methods suitable for the present device are disclosed in U.S. Pat. Nos. 10,657,814 and 11,164,452, which are both incorporated herein by reference in their entirety.

Once a vehicle is detected as having parked in the NO PARKING area 150, a violation is deemed to have occurred. Alternatively, a grace period can be timed upon such detection (e.g. 5 minutes, 10 minutes, etc.). No violation will be deemed to have occurred if the vehicle exits the NO PARKING area 150 before the grace period expires. The grace period allowance is useful for monitoring loading zones where extended parking is not allowed, but short term presence of the vehicle is permitted in the monitored area to perform a loading or unloading tasks. The grace period (e.g. 10 minutes) can be set to an appropriate maximum time to perform the loading and unloading, but the short limitation will keep persons from parking their car in the loading/unloading zone for any longer time periods. Thus congestion in the loading/unloading zone can be reduced.

At (or before or after) the time of violation, image (video or still image data) and any calculated information are relayed to a back office computing system (e.g. central computer, cloud computer or other remote computing system) for issuance of the parking violation, or relay to the municipality for issuance of the violation notice. This same information may also or alternatively be relayed to parking enforcement officers using handheld mobile applications such as disclosed in U.S. Pat. Pub. No. 2017/0032582 A1, which is incorporated herein by reference in its entirety.

The bollard 100 is configured via its software code to maintain the logical state of the areas being monitored to record and can report violations to the municipality through use of a hosted back office application and/or handheld mobile applications in real time. In cases where internet connectivity is temporarily unavailable, images and calculated information are stored locally in the Bollard's memory until the connection is restored.

The bollard 100 can also time the length of the violation and take additional action as appropriate, including notifying the back office computing system when certain milestones occur, such as 10 minutes, 20 minutes, etc., and/or the bollard can also send notification to a towing service to tow the illegally-parked vehicle.

As a vehicle in the monitored NO PARKING area 150 exits the monitored area 150, any timers applicable to the event are reset awaiting the next vehicle detection event.

Depending on the environment surrounding the enforcement bollard 100, lights may be illuminated to indicate no parking status or violation occurrence. Targeted lights or a flashing light can be provided to the bollard 100 and used to improve camera vision on the area where an image is captured by the camera.

Emergency and official vehicles can be exempted from violation issuance through use of license plate recognition and image review by the municipality officers or via automated algorithms.

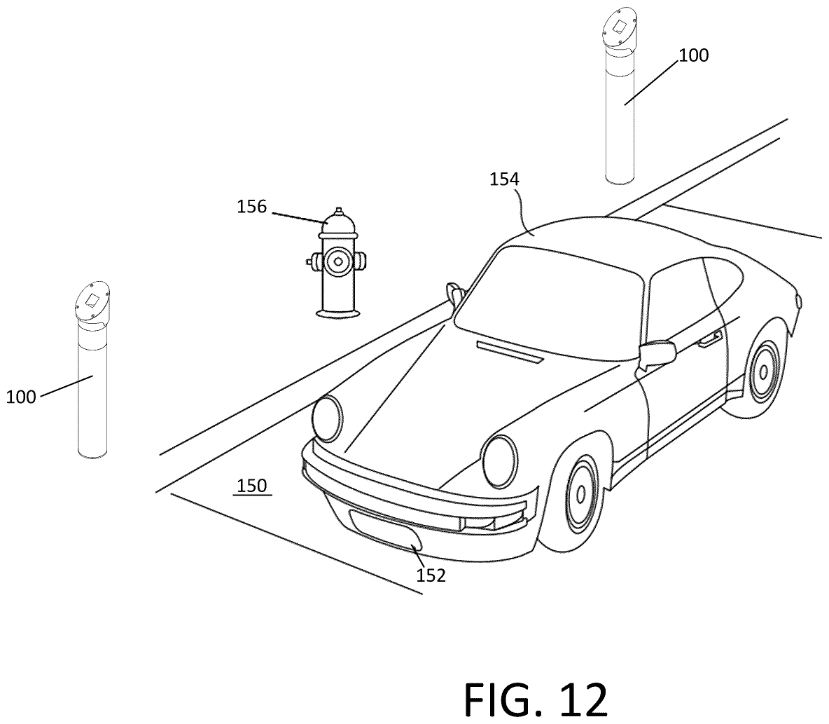

Referring to FIG. 12, in additional embodiments, two or more parking enforcement devices 100 may be combined to monitor a larger area 150 in which a single enforcement device cannot cover alone, such as a fire lane or bus stop in which the monitored area may be as long as 75 feet in length or more. In this embodiment, a group of enforcement devices 100 are configured to work together to determine entry in the monitored area 150 by the vehicle 154, capture the enforceable data such as time the vehicle entered the area by one enforcement device 100, license plate number by another such device 100 and exit by the second monitoring device 100, or even by a third monitoring device 100. Physical location of the vehicle 154 stops can be determined via combined usage of multiple cameras. Moreover, obstructions that would block the field of view of the camera(s) 114 in one of the enforcement devices can be avoided by relying instead on the view offered by a camera of a different enforcement device 100 having an overlapping monitoring area.

While the invention has been described in connection with what is presently considered to be the most practical and preferred embodiments, it will be apparent to those of ordinary skill in the art that the invention is not to be limited to the disclosed embodiments. It will be readily apparent to those of ordinary skill in the art that many modifications and equivalent arrangements can be made thereof without departing from the spirit and scope of the present disclosure, such scope to be accorded the broadest interpretation of the appended claims so as to encompass all equivalent structures and products. Moreover, features or aspects of various example embodiments may be mixed and matched (even if such combination is not explicitly described herein) without departing from the scope of the invention.

What is claimed is:

1. A parking enforcement device, comprising:
an elongated hollow body;
a window provided to the tubular body;
a battery;
an internal frame assembly disposed inside of the elongated hollow body, the internal frame assembly defining a cavity in which the battery is located;
a camera disposed inside of the elongated hollow body;
a camera support pole extending vertically upwards from the internal frame assembly,
wherein the camera is secured to the camera support pole and located vertically along the camera support pole such that the camera views outward through the window.

2. The parking enforcement device of claim 1, wherein the window is a portion of the elongated hollow body.

3. The parking enforcement device of claim 1, further comprising a cap disposed vertically atop the elongated hollow body.

4. The parking enforcement device of claim 3, wherein a top surface of the cap comprises a planar surface that is angled to intersect a horizontal plane.

5. The parking enforcement device of claim 4, further comprising a solar panel disposed on the top surface of the cap.

6. The parking enforcement device of claim 1, further comprising a plurality of solar cells disposed on a surface on top of the elongated hollow body.

7. The parking enforcement device of claim 6, wherein the surface on top of the elongated hollow body comprises a planar surface that is angled to intersect a horizontal plane.

8. The parking enforcement device of claim 1, further comprising a pair of battery enclosure panels secured to the internal frame assembly and located such that the pair of battery enclosure panels enclose the cavity in which the battery is located.

9. The parking enforcement device of claim 1, further comprising a base plate, wherein the elongated hollow body is disposed atop the base plate.

10. The parking enforcement device of claim 1, wherein the elongated hollow body has a constant outer diameter from a top to a bottom thereof.

11. The parking enforcement device of claim 1, further comprising an electronics board secured to the internal frame assembly.

12. The parking enforcement device of claim 11, wherein the electronics board includes a control board comprising a microprocessor and memory, wherein the camera is electronically coupled to the control board.

13. The parking enforcement device of claim 11, wherein the electronics board includes wireless communications means.

14. The parking enforcement device of claim 11, further comprising a plurality of solar cells disposed on a surface on top of the elongated hollow body, wherein the electronics board includes a solar charge controller that is electrically coupled to the plurality of solar calls and to the battery.

15. The parking enforcement device of claim 11, wherein the electronics board includes an impact sensor.

16. The parking enforcement device of claim 1, wherein the control board includes a processor, the processor configured to monitor an area designated as NO PARKING for the presence of a vehicle in the area designated as NO PARKING.

17. The parking enforcement device of claim 16, wherein the processor is configured to utilize the camera to perform a machine vision analysis of the area designated as NO PARKING for the presence of vehicles in the area designated as NO PARKING.

18. The parking enforcement device of claim 16, wherein the processor is configured to utilize the camera to capture an image of a license plate of the vehicle in the area designated as NO PARKING and transmit the image of the license plate to a back office computing system.

19. The parking enforcement device of claim 16, wherein the processor is configured to determine that a parking violation has occurred upon determining that the vehicle is present in the area designated as NO PARKING.

20. The parking enforcement device of claim 16, wherein the processor is configured to initiate a request for towing services upon an expiration of a predetermined period of time following a determination that the vehicle is present in the area designated as NO PARKING without the vehicle having left the area designated as NO PARKING.
